(19) United States
(12) Patent Application Publication
(10) Pub. No.: US 2004/0237667 A1
(43) Pub. Date: Dec. 2, 2004

(54) APPARATUS FOR DETECTING THE STRESS DISTRIBUTION OF METAL STRIPS STRESSED BY TENSION OF THE STRIP

(76) Inventors: Frank Berger, Hullhorst (DE); Axel Berger, Kaarst (DE)

Correspondence Address: PROSKAUER ROSE LLP, PATENT DEPARTMENT, 1585 BROADWAY, NEW YORK, NY, 10036-8299, US

(21) Appl. No.: 10/491,178

(22) PCT Filed: Oct. 7, 2002
(86) PCT No.: PCT/EP02/11205

(30) Foreign Application Priority Data
Oct. 5, 2001 (DE) 101 49 240.5
Jan. 22, 2002 (DE) 102 02 413.8

(51) Int. Cl. G01L 5/00

(52) U.S. Cl. 73/862.55

(57) ABSTRACT

The present invention relates to a device for detecting the stress distribution of metal strips stressed by tension of the strip, comprising a measuring roller (A, B), comprising at least one receptacle (2) formed in the measuring roller body (1) of the measuring roller (A, B), comprising a measuring sensor (6) which sits in the receptacle (2), comprising a force-transmitting element (5) fitting in the receptacle (2), which has a loading shoulder (5b) which acts on the measuring sensor (6), said loading shoulder's cross-sectional area is smaller than the cross-sectional area of the receptacle (2), and comprising a cover (7) sitting in the opening of the receptacle (2) said cover's outwardly directed surface is arranged substantially flush to the circumferential surface of the measuring roller body (1) of the measuring roller (A, B) and which is connected to the force-transmitting element by means of a press connection. With the device according to the invention, the stresses occuring in a metal strip can be detected reliably and with a minimised risk of perturbing influences.

The invention relates to a device for detecting the stress distribution of metal strips stressed by tension of the strip. Such devices are used, for example, to measure stresses appearing in the respectively processed strip during cold rolling and to derive control signals therefrom for devices which regulate the distribution of tensile forces acting on the strip.

In order to be able to measure the stress distribution, the metal strip is guided around the measuring roller. The measurement is then made by force measuring sensors located in the roller with which the strip is scanned. The strip deflecting forces acting on the measuring roller result in bending stresses in the measuring roller which cause deformation of the cross-section of the measuring roller.

A fundamental problem with such detection of the stress distribution is the risk of damage to the sensors and the fact that contamination of the measuring sensors occurs. Thus, in the past attempts have made to screen the measuring sensors from the environment such that on the one hand, an optimal measurement accuracy is achieved and on the other hand, destruction of the sensors or any contamination of the measuring sensors having a negative influence on the measurement result is prevented.

An attempt of this kind is known from DE 26 30 410 A1. In this measuring roller the measuring sensors are inserted in receptacles formed in the measuring rollers. In order to protect the measuring sensors, the measuring roller is covered with a steel jacket which has been shrunk on.

Similarly, it has been proposed in DE 198 38 457 A1 that the measuring roller body should be surrounded by a jacket formed by a thin metal tube. In this case, the force-transmitting element used to transmit the forces acting during operation is slightly smaller than and sits in a cylindrically shaped receptacle on the sensor which receives the forces, said sensor being arranged on the base of the receptacle. The joint between the force-transmitting element and the inner wall of the receptacle is closed by means of a sealing compound so that the force-transmitting element is held in the receptacle without play.

The advantage of measuring rollers surrounded by a jacket is that the properties of the jacket material can be optimally matched to the properties of the sheet metal to be rolled. Damage to the surface of the sheet metal can thus be avoided to a large extent. At the same time, the jacket protects the measuring device from contamination. In practice however, it must be accepted that if the jacket has a fairly large wall thickness, some considerable falsification of the measurement result will occur. Thus, it has been established that already in the case of jackets having a thickness of 2 mm, large force diversions occur which significantly falsify the measurement result.

Starting from the prior art described hereinbefore, it was the object of the invention to provide a device with which the stresses formed in a metal strip can be detected reliably and with a minimised risk of perturbing influences.

This object is solved by a device for detecting the stress distribution of metal strips stressed by tension of the strip, which comprises a measuring roller, at least one receptacle formed in the measuring roller body of the measuring roller, a measuring sensor which sits in the receptacle, a force-transmitting element which fits in the receptacle, which has a loading shoulder which acts on the measuring sensor, said loading shoulder's cross-sectional area is smaller than the cross-sectional area of the receptacle, and having a cover which sits in the opening of the receptacle said covers outwardly directed surface is arranged substantially flush to the circumferential surface of the measuring roller body.

In the device according to the invention, a force-transmitting element is provided whose diameter is dimensioned such that it sits in the receptacle with play. The loading of the measuring sensor takes place via the loading shoulder of the force-transmitting element. The forces received by the measuring roller during operation are introduced into the force-transmitting element by the cover resting on the force-transmitting element which seals the opening of the receptacle apart from a joint of narrow width, but preferably joint-free. The cover and force-transmitting element are in this case interconnected by a press fit. At the same time, the force-transmitting element is suitably connected to the measuring roller. In this way it is ensured that the forces acting on the cover are transferred to the measuring sensor correctly and without any falsifications by external influences and from said sensor are supplied as an exact image of the actual loads to a measuring and control device.

As in the prior art explained initially, in a device according to the invention the measuring roller body of the measuring roller can be surrounded by a jacket preferably consisting of a plastic optimised with regard to sparing the surface of the strip, which jacket protects the measuring sensor sitting in a receptacle of the measuring roller, from external influences. The embodiment of the force-transmitting element according to the invention and its connection with the cover achieved by a press fit make it possible to use the advantages of a measuring roller provided with a jacket without the risk of any falsification of the measurement result which exists in the prior art.

The cover itself can likewise be pressed into the opening of the receptacle so that regardless of the presence of a jacket, a permanently secure sealing of the receptacle is ensured at the same time with a substantially jointless transition between the circumferential surface of the measuring roller and the cover. In this way, on the one hand, loose particles which could falsify the measurement result are reliably prevented from settling in the area of the cover. On the other hand, the press fit ensures that the surface of the respectively processed strip is not damaged by accumulations of dirt particles on the circumferential surface of the measuring roller.

The cover can be pressed into the receptacle in a conventional fashion by shrinking the cover into the receptacle. Alternatively, shaping elements such as sloping wedges or the like can be provided to facilitate mechanically assisted pressing of the cover into the receptacle. The pressure acting on the cover produces a force by which the measuring sensor is pre-stressed in a defined fashion also in the non-operative state.

Therefore it is expedient to determine the forces produced during pressing in of the cover by means of the measuring sensor in order to thus obtain a clear prediction of the actual loading state of the sensor in the ready assembled state.

If the cover does not sit jointless in the opening of the receptacle, the existing joint should be sealed by means of a suitable sealing compound in order to avoid any contamination which has penetrated under the jacket, such as penetrating oils, etc., from penetrating into the receptacle.

A particularly advantageous embodiment of the invention in certain cases of usage of measuring rollers according to the invention consists in the cover being respectively supported via supporting section on the force-transmitting element whose cross-sectional area is smaller than the cross-sectional area of the force-transmitting element in the area of the loading shoulder via which the loading of the measuring sensor is accomplished. When constructing such a supporting shoulder between the cover and the force-transmitting element, it is ensured that the forces acting on the cover are introduced into the force-transmitting element in a concentrated fashion and transferred from said element onto the measuring sensor. This makes it possible for the measuring sensor, the shape of the force-transmitting element and the shape of the cover to be matched to one another such that a continuously optimally exact measurement result is achieved.

According to another embodiment of the invention the measuring sensor is constructed as ring-shaped. With such a ring-shaped measuring sensor the loads produced during operation of the measuring roller can be determined particularly reliably.

This applies particularly when the force transmitting element has a shaft section having one end connected fixedly to the measuring roller. The loads of the measuring roller corresponding to the stresses in the strip guided around the measuring roller can thus be determined particularly clearly.

The loading shoulder is preferably constructed as a collar which encircles the shaft section so that the measuring sensor and the force-transmitting element can be arranged coaxially to one another and the loading shoulder can act with its underside facing away from the outside of the measuring roller on the measuring sensor. With this embodiment and arrangement of the measuring sensor and the force-transmitting element it is ensured that the loads produced during operation of the measuring roller are correctly detected by the measuring sensor in terms of their direction of action and distribution.

Generally, in order to achieve problem-free detection of the measurement signals, it is necessary to pre-stress the measuring system formed from the cover, force-transmitting element and measuring sensor. The force with which the measuring sensor is pre-stressed can be set exactly by the depth over which the force-transmitting element is inserted into the receptacle.

The multi-part design of the assembly formed from the cover and the force-transmitting element, used to transmit the forces produced, according to the invention has the advantage that different materials can be used to manufacture the cover and the force-transmitting element.

Thus, the cover can be made of a particularly wear-resistant material whereas a shaft constructed on the force-transmitting element for connection to the measuring roller, can consist of a tough material which is especially well capable of absorbing the loads produced during operation of the measuring roller.

The particular advantage of the embodiment of a measuring device according to the invention is thus that in a first operation the loading shoulder, where applicable with a shaft constructed thereon or connected thereto, can be pre-assembled and adjusted in the receptacle of the measuring roller. The cover is then pressed with the loading shoulder wherein, insofar as this is provided, said cover is simultaneously pressed into the opening of the receptacle. In this way, the position of the loading shoulder can be aligned exactly with respect to an optimum measuring result without this resulting in any hindrance by the cover.

The problem-free detection of the forces of the measuring roller which reflect the stress distribution in the strip being inspected can be additionally assisted by the fact that the cover and/or force-transmitting element has shaping elements which bring about a directional introduction of forces acting on the cover onto the force-transmitting element. These shaping elements can, for example, be constructed as notches, recesses, grooves or the like which bring about a targeted weakening of the force-transmitting element and/or the cover and specify a correspondingly preferred direction of deformation of the force transmission.

In other cases in which it is not expedient to introduce the forces received by the cover into the measuring sensor in a concentrated fashion because of the special features of deformation of a device according to the invention caused by the jacket, the supporting section explained hereinbefore should be dispensed with however and the press connection between the cover and the force-transmitting element should be constructed such that the cover rests flat on the upper side of the force-transmitting element allocated to it.

Further advantageous embodiments of the invention are given in the dependent claims and are explained in detail below with reference to a drawing which shows exemplary embodiments. In the figures:

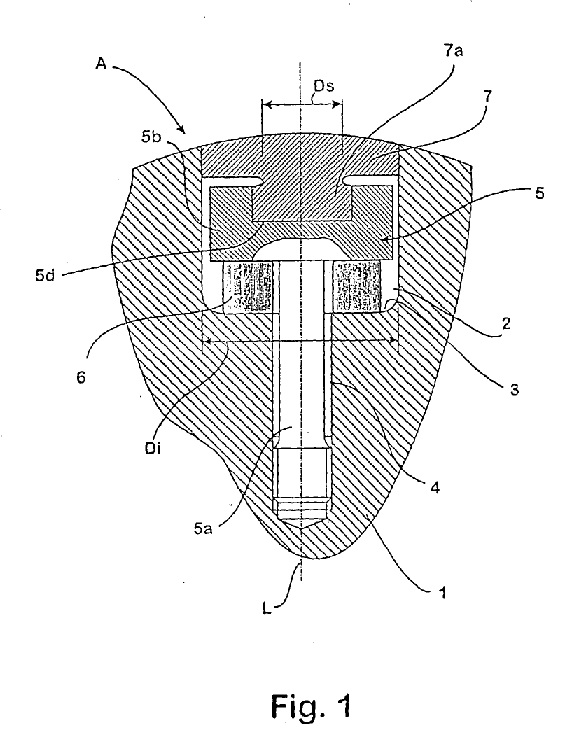

FIG. 1 is a schematic cross-sectional view of a first measuring roller,

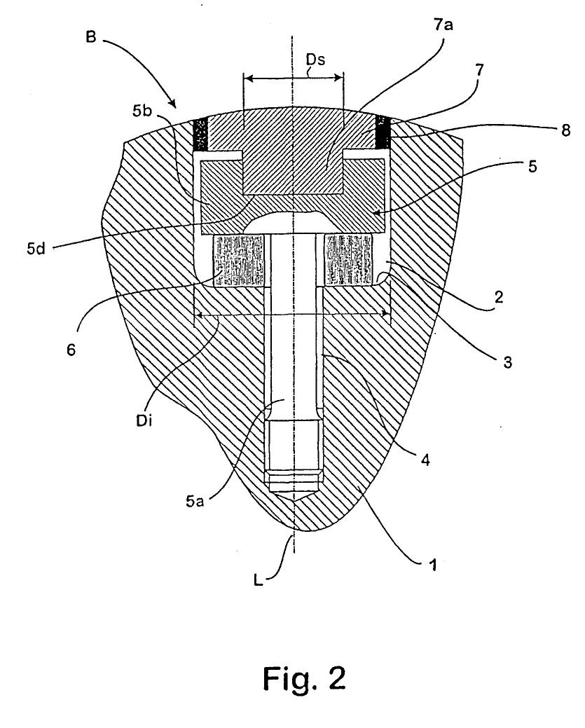

FIG. 2 is a schematic cross-sectional view of a second measuring roller,

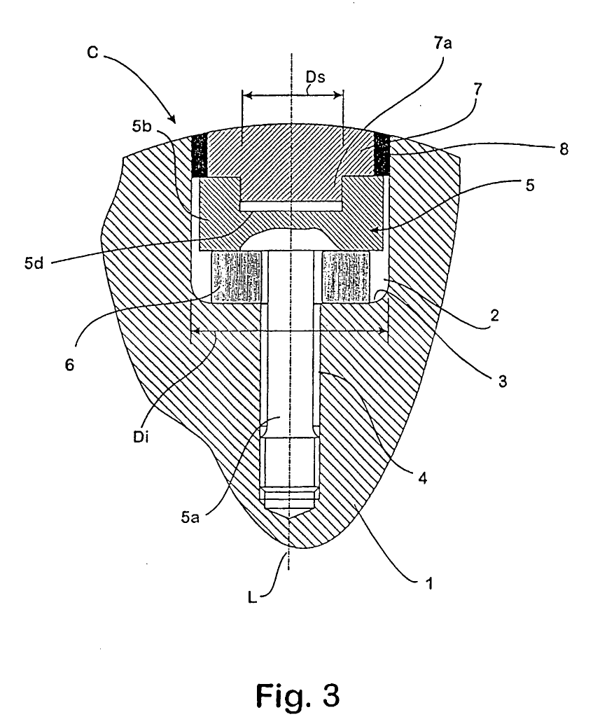

FIG. 3 is a schematic cross-sectional view of a third measuring roller,

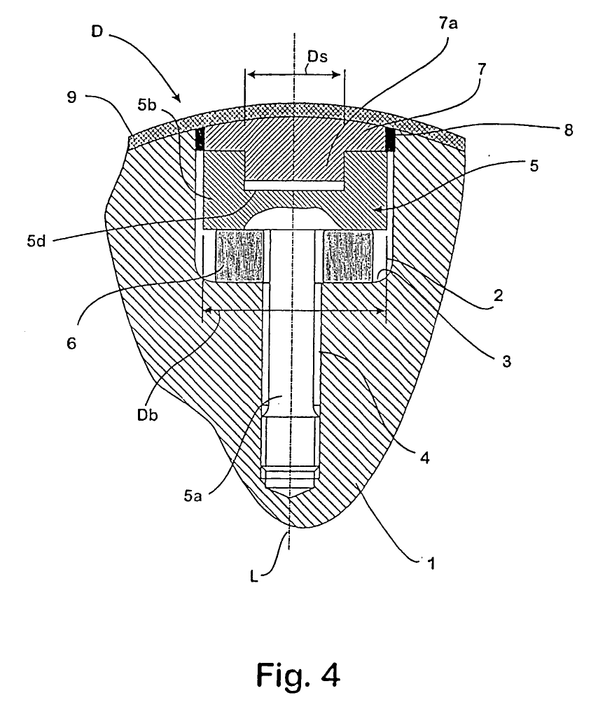

FIG. 4 is a schematic cross-sectional view of a fourth measuring roller.

The measuring rollers A to D shown in the figures are typically used in cold rolling mills. The steel strip processed in the cold rolling mill, which is not shown here, is guided over the circumferential surface of the measuring rollers A, B, C, D.

The measuring roller bodies 1 of the measuring rollers A to D, made of a steel, respectively have at least one circular cross-section receptacle 2 constructed in the fashion of a blind hole, in whose base 3 there is additionally respectively formed a bore 4 provided with an internal thread adjacent to its bottom and aligned coaxially to the longitudinal axis L of the receptacle 2.

A shaft 5a with a threaded section formed at one end is screwed into the bore 4. At its other end associated with the opening of the receptacle 2, said shaft 5a bears a loading shoulder 5b which is constructed as a collar which encircles said shaft 5a. In this case, the diameter Db of the loading shoulder 5b is smaller than the internal diameter Di of the receptacle 2.

The shaft 5a and the loading shoulder 5b carried by it jointly form a force-transmitting element 5 via which a measuring sensor 6 constructed as ring-shaped and arranged coaxially to the longitudinal axis L is loaded. For this purpose, the measuring sensor 6 is tensioned between the loading shoulder 5b and the base 3 of the receptacle 2 such that the loading shoulder 5b acts on the measuring sensor 6 with its underside facing away from the opening of the receptacle 2.

A depression 5d is formed in the upper side of the force-transmitting element 5. A shoulder 7a formed on the underside of a cover 7 and being protrusive from said cover is pressed into the depression 5d. In this way the cover 7 is fixedly connected to the force-transmitting element 5.

The cover 7 is constructed as circular and aligned coaxially to the longitudinal axis L. Its diameter is dimensioned such that it substantially completely fills the opening of the receptacle 2.

The profile of the outer surface 7a of the cover 7 is matched to the profile of the circumferential surface of the respective measuring roller body 1 so that the cover 7 is fitted flush into the receptacle 2. The matching of the cover 7 to the profile of the circumferential surface 1 can be prepared by suitable shaping already during the manufacture of the cover 7 and completed by machining treatment after the cover 7 has been assembled. In the case of the measuring rollers A, B (FIGS. 1 and 2), the length of the shoulder 7a is greater than the depth of the depression 5d. In this way, the shoulder 7a forms a supporting shoulder whose diameter Ds is smaller than the diameter Db of the loading shoulder 5b. The shoulder 7a thus has a smaller cross-sectional area than the loading shoulder 5b. In this way, the forces received by the cover 7 are transmitted in a concentrated fashion into the force-transmitting element 5 and from there to the measuring sensor 6.

If it is found that as a result of the presence of a supporting shoulder because of the interplay of the jacket 9 and cover 7, there are excessive deformations in the area of the edge of the cover 7 which falsify the measurement result, this can be counteracted by supporting the cover 7 over a larger area on the upper side of the force-transmitting element 5. In order to make this possible, in the case of the measuring roller C, D, the length of the shoulder 7a of the cover 7 is smaller than the depth of the depression 5d so that the cover 7 lies with its underside flat on the top of the force-transmitting element 5.

In the exemplary embodiment shown in FIG. 1 the cover 7 is pressed into the opening of the receptacle 2. In this way the receptacle 2 is tightly closed without any joints with respect to the surroundings of the measuring roller A. The pressing-in force is selected such that, on the one hand, a permanently tight fit of the cover 7 is ensured and on the other hand, any penetration of contamination into the receptacle 2 is reliably avoided.

In the exemplary embodiment shown in FIGS. 2 and 3 the cover 7 sits in the opening of the receptacle 2 with play. The joint remaining between the inner edge of the opening of the receptacle 2 and the outer edge of the cover 7 is closed by a sealing compound 8.

The measuring roller body 1 of the measuring roller D shown in FIG. 4 is surrounded by a jacket 9 made of a synthetic material which is softer than the steel used to manufacture the measuring roller body 1 of the measuring rollers A, B. In this case, the thickness of the jacket is dimensioned such that the demands imposed on the grinding dimension in practice (grinding dimension ≧2 to 3 mm) are reliably satisfied.

### REFERENCE NUMBERS

A, B Measuring rollers

L Longitudinal axis of the receptacle 2

Db Diameter of the loading shoulder 5b

Di Internal diameter of the receptacle 2

Ds Diameter of the shoulder 7a

1 Measuring roller body

2 Receptacle

3 Base of receptacle 2

4 Bore

5 Force-transmitting element

5a Shaft

5b Loading shoulder

5d Depression

6 Measuring sensor

7 Cover

7a (Supporting) shoulder of cover 7

8 Sealing compound

9 Jacket

1. A device for detecting the stress distribution of metal strips stressed by tension of the strip comprising;
a measuring roller;
at least one receptacle formed in the measuring roller body of the measuring roller;
a measuring sensor which sits in the receptacles;
a force-transmitting element fitted in the receptacle, which has a loading shoulder acting on the measuring sensor, said loading shoulder's cross-sectional area is smaller than the cross-sectional area of the receptacle; and
a cover sitting in the opening of the receptacle said cover's outwardly directed surface is arranged substantially flush to the circumferential surface of the measuring roller body of the measuring roller and which cover is connected to the force-transmitting element by means of a press connection.

2. The device according to claim 1, wherein the measuring roller body is surrounded by a jacket which completely covers the cover.

3. The device according to claim 1, wherein the cover sits tightly in the opening of the receptacle.

4. The device according to claim 1, wherein the force-transmitting element has a depression on its side associated with the outside of the measuring roller into which depression a shoulder formed on the surface of the cover associated with the force-transmitting element is pressed.

5. The device according to claim 1, wherein the cover is pressed into the opening of the receptacle and seals this completely.

6. The device according to claim 1, wherein a joint remaining between the edge of the cover and the opening of the receptacle is sealed with a sealing compound.

7. The device according to claim 1, wherein the cover rests on the surface of the force-transmitting element allocated to it.

8. The device according to claim 1, wherein between the cover and the force-transmitting element there is formed a supporting shoulder which has a smaller cross-sectional area than the loading shoulder of the force-transmitting element.

9. The device according to claim 1, wherein the force-transmitting element has one end fixedly connected to the measuring roller and has the loading shoulder at its other end.

10. The device according to claim 1, wherein the measuring sensor is constructed as ring-shaped.

11. The device according to claim 1, wherein the force-transmitting element has a shaft section whose one end is fixedly connected to the measuring roller.

12. The device according to claim 11, wherein the loading shoulder is constructed as a collar which encircles the shaft section.

13. The device according to claim 10, wherein the measuring sensor and the force-transmitting element are arranged coaxially and the loading shoulder acts on the measuring sensor with its lower side facing away from the outside of the measuring roller.

14. The device according to claim 9, wherein the fixed connection between the force-transmitting element and the measuring roller is formed by a screw connection.

15. The device according to claim 11, wherein the force-transmitting element has at least one section which consists of a different material than the section of the force-transmitting element adjacent to it.

16. The device according to claim 1, wherein the cover consists of a material whose properties differ from the properties of the material from which the shaft of the force-transmitting element is made.

17. The device according to claim 1, wherein the receptacle has a circular cross-section.
